(19) United States
(12) Patent Application Publication
(10) Pub. No.: US 2003/0047892 A1
(43) Pub. Date: Mar. 13, 2003

(54) Agricultural vehicle

(76) Inventor: Roger W. Goddard, Essex (GB)

Correspondence Address: LARRY W. MILLER, NEW HOLLAND NORTH AMERICA , INC., P.O. BOX 1895, NEW HOLLAND, PA, 17557, US

(21) Appl. No.: 10/236,539

(22) Filed: Sep. 6, 2002

(30) Foreign Application Priority Data
Sep. 8, 2001 (GB) 01.21.742.1

(51) Int. Cl. B60G 17/005

(52) U.S. Cl. 280/5.514

(57) ABSTRACT

An agricultural vehicle is disclosed having a sprung chassis, a rear axle assembly which forms part of the unsprung mass of the tractor and is connected to the chassis by means of a hydraulic suspension, and a hitch assembly mounted on the chassis. The hitch assembly forms part of the sprung mass of the vehicle when operating in a transport mode and the hydraulic suspension additionally has a working mode, in which the suspension is locked, in order to maintain the chassis at a fixed height relative to the rear axle assembly.

### BACKGROUND OF THE INVENTION

The present invention relates to a self-propelled agricultural vehicle such as an agricultural tractor, and more particularly, to a hydraulic suspension mechanism for a tractor rear axle.

In conventional tractors, the chassis is constituted by the engine and transmission housing. The front and rear axles are fixed in relation to the chassis. In some cases, the cabin may be sprung relative to the chassis to afford some comfort to the driver or the front axle may be sprung but the read wheels and rear axle are not sprung. Because of the very large unsprung mass of the rear wheels, rear axle, engine and transmission, such tractors are not well suited to travel at speed along public roads.

Tractors that are better suited to travel along normal roads have been proposed, for example in Great Britain Patent No. 2,252,278, which have a chassis connected by a suspension to the wheels and wheel axles. In such tractors, as is the case with the more conventional tractors described above, the hitch assembly used for towing agricultural implements, such as a plough, is mounted directly on the axle, that is to say on the unsprung mass of the tractor.

U.S. Pat. No. 5,404,958 discloses an agricultural tractor which includes an axle body and a vehicle substructure. A generally vertical lifting structure is rigidly attached to the vehicle substructure and engages a lifting frame which is adjustable in height. The lifting frame carries coupling and/or drive arrangements for implements. A hydraulic cylinder is arranged between the lifting frame and the axle body. The cylinder is connected to a hydro-pneumatic pressure reservoir and functions as an elastic spring support. A lock can be engaged to fix the lifting structure rigidly to the axle body. A transport lock can be selectively engaged to rigidly connect the lifting structure to the lifting frame. A selector valve selectively connects the pressure chamber of the hydraulic cylinder to either a hydro-pneumatic pressure reservoir or to a lifting control arrangement.

### SUMMARY OF THE INVENTION

It is an object of the present invention to provide a hydraulic suspension mechanism for the rear axle of an agricultural tractor that has a working mode of operation.

It is a feature of this invention that the hydraulic suspension maintains the chassis of the tractor at a fixed height relative to the rear axle of the tractor.

It is an advantage of this invention that the working mode of operation of the tractor rear axle hydraulic suspension mechanism emulates a rigid rear axle assembly.

It is another advantage of this invention that the tractor will have improved performance when operating over paved roadways.

According to the present invention, there is provided an agricultural vehicle having a sprung chassis, a rear axle assembly which forms part of the unsprung mass of the tractor and is connected to the chassis by means of a hydraulic suspension, and a hitch assembly mounted on the chassis such that the hitch assembly forms part of the sprung mass of the vehicle when operating in a transport mode, characterised in that the hydraulic suspension additionally has a working mode, in which the suspension is locked, in order to maintain the chassis at a fixed height relative to the rear axle assembly.

Preferably, the suspension may have a further working mode in which suspension movements are not totally eliminated but their amplitude is limited.

In the present invention, when operating in transport mode the hitch and any implement attached to it forms part of the sprung weight of the vehicle, thereby enabling the vehicle to travel safely at speed along paved roads surfaces. On the other hand, when the vehicle is in working mode, for example when it is used for towing a plough in a field, the chassis is locked by the suspension to the rear axle assembly, or only allowed a limited degree of movement and the ensemble behaves in the same or substantially the same manner as a conventional tractor have a rigid rear axle.

It is preferred that the suspension should have gas on oil struts so that the height of the chassis may be dynamically varied. In this case, by raising and lowering the suspension height, the struts of the suspension may be controlled dynamically based on a signal derived from a suitable sensor in order, for example, to maintain constant draught. Furthermore, by elimination of some of the gas accumulator capacity, the amplitude of suspension movements can be limited.

These and other objects, features and advantages are accomplished according to the instant invention by providing an agricultural vehicle having a sprung chassis, a rear axle assembly which forms part of the unsprung mass of the tractor and is connected to the chassis by means of a hydraulic suspension, and a hitch assembly mounted on the chassis. The hitch assembly forms part of the sprung mass of the vehicle when operating in a transport mode and the hydraulic suspension additionally has a working mode, in which the suspension is locked, in order to maintain the chassis at a fixed height relative to the rear axle assembly.

### BRIEF DESCRIPTION OF THE DRAWINGS

The advantages of this invention will become apparent upon consideration of the following detailed disclosure of the invention, especially when taken in conjunction with the accompanying drawings, wherein:

FIG. 1 is a schematic side view of a tractor of the invention; and

FIG. 2 is a diagram to show the forces acting on a plough connected to a free linkage.

### DETAILED DESCRIPTION OF THE PREFERRED EMBODIMENT

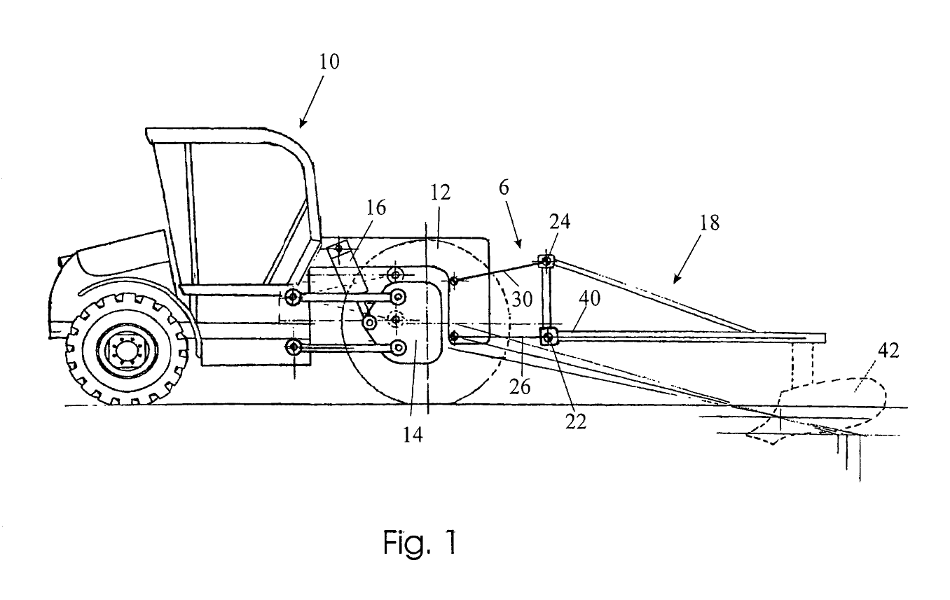

Referring first to FIG. 1, a tractor generally designated 10 comprises a chassis 12 mounted on the rear axle 14 by means of a suspension 16 that comprises gas on oil struts. A hitch assembly 6 is mounted on the chassis 12 so as to form part of the sprung mass of the tractor 10. The hitch assembly 6 is designed for attachment of an implement, such as a plough 18, which may be connected additionally to the power takeoff shaft of the tractor 10.

The implement to be towed by the tractor 12 has a rigid frame 40 at its front end which is coupled to the hitch assembly at two lower forks 22 and an upper ring 24. The lower forks 22 are formed on the ends of arms 26 that are pivotably mounted on the chassis 12 at a point A. The ring 24 is arranged on the free end of a rod 30 of which the other end is pivotably mounted on the chassis 12.

The arms 26 are designed to be lowered and raised by a hydraulic system not shown in the drawings. When the tractor is in a working mode, that is when it is being used to tow an implement, the arms 26 are lowered, as illustrated. When the tractor is in a transport mode, that is when the implement is being carried from one working location to another, perhaps along a metalled road, the arms 26 are raised and the implement is carried clear of the ground. Hydraulic jacks are provided for the purpose of raising and lowering the arms 26.

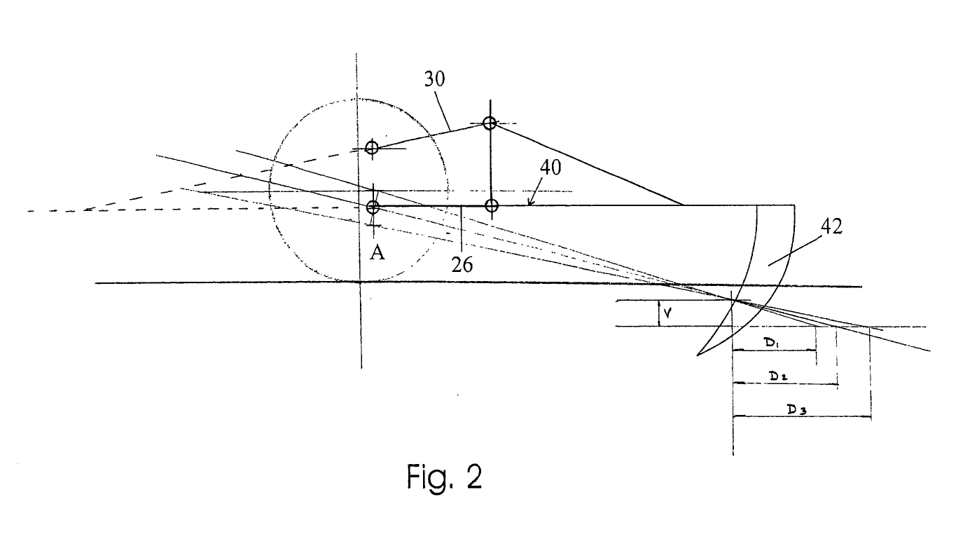

As is well known, when using a hitch, as illustrated in the drawings, a plough will find its own working depth automatically. This will be explained briefly by reference to FIG. 2 but reference is made to an article on Page 200 of the issue of Farm Implement and Machinery Review published on Feb. 1, 1966 for a fuller explanation.

In FIG. 2, the rigid frame of the plough is designated 40 and the blades are designated 42. The forces acting on the plough comprise a vertical component V which is substantially constant and dependent upon such factors as the weight of the plough and soil reaction forces which may act upwards or downwards. The horizontal draught force D1, D2 or D3 which is dependent on ploughing depth, blade size and the nature of the soil. The horizontal draught force does not vary significantly with speed, provided the speed is within the normal working range for tillage equipment (4-14 kph).

The plough pivots about the pivot point A of the arms 26. A position of stable equilibrium of the blade 42 prevails when the line of action of the resultant of the horizontal and vertical force components passes through the pivot point A of the arms 26. If disturbed from this position, the forces acting on the blade will return it to this stable position in a similar manner to the forces on a pendulum. Thus, when the soil is easy to work, the blade with penetrate more deeply and conversely when working with harder soil the depth of the furrow with automatically be reduced.

The depth of the plough furrow can be altered by changing the geometry of the hitch. Thus by altering the position of the rod 30 relative to the bracket 32 it is possible to control the depth. To this end, provision may be made to enable the end of the rod 30 to be mounted in any of several different positions.

In the prior art, regardless of whether tractors have been constructed with or without a suspension, the hitch has been mounted on the unsprung mass, i.e. the hitch was always rigid with the rear axle. This has serious disadvantages in transport mode as it limits the speed at which the tractor can be driven. By contrast, in the present invention, the hitch is mounted on the chassis 12 and is therefore sprung in the transport mode. The plough can thus be raised off the ground using the jacks 34 and the tractor can travel safely at speeds on metalled roads with the plough held clear of the ground.

When in working mode, the hydraulic suspension 16 of the tractor is used to prevent or limit movement of the chassis relative to the rear axle so that the tractor as a whole behaves in the same way as one without suspension.

Vehicle suspensions comprise a spring element and a shock absorbing or damping element. The spring element can be a leaf spring or a helical spring but in the case of a gas on oil struts it is formed by compressed air. The oil is used for damping and by pumping oil into the strut it can also be used to set the height of the chassis above the rear axle. The damping is effected by a double acting piston (one having working chambers on both sides) with means for throttling return flow from one of its working chambers to the other to vary the damping effect. When communication between the two working chambers is prevented completely, the suspension is effectively locked. If the some of the gas accumulator capacity is eliminated, the maximum degree of movement of the suspension is limited.

A suspension with gas on oil struts can thus be used to set the height of the chassis above the rear axle, thereby raising and lowering all three points of the hitch. The height of the chassis can be set in this manner and maintained constant during ploughing, relying on the above described pendulum action of the three point hitch to determine the furrow depth.

Alternatively, by pumping oil into the struts, the height of the suspension may be controlled in a closed feedback loop to maintain constant draught. In this case, for example, the draught can be sensed and the chassis height varied in a direction to maintain the draught at a desired predetermined level.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

Having thus described the invention, what is claimed is:

1. In a tractor having a sprung chassis, a rear axle assembly which forms part of the unsprung mass of the tractor and is connected to the chassis by means of a hydraulic suspension, and a hitch assembly mounted on the chassis such that the hitch assembly forms part of the sprung mass of the vehicle when operating in a transport mode of operation, the improvement comprising:
the hydraulic suspension is provided with a first working mode of operation in which the hydraulic suspension is locked, in order to maintain the chassis at a fixed height relative to the rear axle assembly.

2. The tractor of claim 1 wherein the hydraulic suspension is provided with a second working mode of operation in which movements of said hydraulic suspension are limited in amplitude.

3. The tractor of claim 2 wherein the hydraulic suspension includes gas on oil struts to enable the height of the chassis to be varied dynamically.

4. The tractor of claim 3 wherein said chassis is maintained at a controlled height when said hydraulic suspension is in the working mode in association with a signal from a sensor responsive to an operating parameter of the towed implement.
